(19) United States
(12) Patent Application Publication
(10) Pub. No.: US 2009/0309350 A1
(43) Pub. Date: Dec. 17, 2009

(54) DEVICE TO PRESENT CONTENT

(75) Inventors: Jeffrey Peter Nobbs, Kowloon (HK); James R. Diaz, Alhambra, CA (US)

Correspondence Address: LEE & HAYES, PLLC, 601 W. RIVERSIDE AVENUE, SUITE 1400, SPOKANE, WA, 99201, US

(73) Assignee: The Brook Studio

(21) Appl. No.: 12/138,016

(22) Filed: Jun. 12, 2008

(51) Int. Cl. B42D 1/00

(52) U.S. Cl. 281/15.1

(57) ABSTRACT

Content is displayed in an apparatus, such as a book, using an input device, an electromechanical device, a light emitting device and an audio device. A user selects an input device coupled with the apparatus. In response to the selection, an object is moved within the apparatus with the electromechanical device while simultaneously flashing light from the light emitting device and playing a sound with the audio device.

### BACKGROUND

This application relates to presenting content and more specifically providing an audio and visual presentation in a book, calendar, games or any printed publication.

Books are constructed with textual material and may include graphical illustrations on their cover. Other books, called pop-up books have graphical content that pop out of the book when the book is open.

Greeting cards are available with a sound chip built into the card. When the card is open, a song or other audible greeting will be played.

These books and cards only provide an audio or a visual experience. In these devices, there is no relation between the visual experience and any audio experience.

### SUMMARY

In one implementation, a method for presenting content in a text book is disclosed. The method includes a text book having an input device, an electromechanical device, a light emitting device and an audio device. An electric signal is provided to start an event in response to selection the input device. In response to the signal, an object is physically moved within the book with the electro-mechanical device while simultaneously flashing a light with the light emitting device and playing a sound with the audio device.

In another implementation, a book is provided. The book includes a movable object having a surface in which characters within a book are attached. An electro-mechanical device is attached to the book to move the object to change an orientation or position of the characters. The book includes a light emitting device and an audio device. A processing device is incorporated in the book to simultaneously activate the electro-mechanical device, the light emitting device and the audio device.

In another implementation, an apparatus containing textual content may be provided. The apparatus incorporates a movable object, an electro-mechanical device, one or more light emitting devices, an audio device, and a processing circuit. The movable object has a surface in which graphic images are attached. The electro-mechanical device is coupled with the apparatus to move the object to change an orientation or position of the graphic images. The light emitting devices are electrically activated. The processing circuit simultaneously activates the electro-mechanical device, the lighting devices and the audio device.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIG. 1 illustrates an exemplary book cover that incorporates sound, light, and mechanical movement in accordance with the claimed embodiment.

FIG. 2 illustrates an exploded view of the components that are used to construct the exemplary book cover shown in FIG. 1.

FIG. 3 illustrates an exploded view of the components that are used to construct the exemplary electrical mechanical device shown in FIG. 2.

FIGS. 4a and 4b illustrates exploded views of a book cover shown in FIG. 1 incorporating an exemplary disk with embedded content.

FIG. 5 illustrates a schematic diagram of a circuit that includes a processing device for controlling the electrical mechanical device, audio components and light emitting device shown in FIG. 2.

FIG. 6 illustrates a flow diagram of a process implemented by the processing device shown in FIG. 5 to produce synchronized sound, light, and mechanical movement.

### DETAILED DESCRIPTION

This disclosure is directed to displaying an animating content. Aspects of the disclosure will be described with content being animated on a cover of a book. However, this disclosure is not intended to be limited to a cover of a book and the animation of content may be applied to devices that are incorporated into other objects, such as one or more pages of a book, a calendar, or a board game.

The book would include a movable object, a light emitting device, and an audio device. The object would have a surface in which characters are displayed. An electro-mechanical device could also be attached to the book to move the object to change an orientation or position of the characters on the objects surface. Although an electro-mechanical device is discussed which rotates a disk, the electro-mechanical device may move other objects. For example the electro-mechanical device may rotate a display wheel in two directions, drive a flap to continuously open and close, drive an object to continuously move back and forth in two directions, cause object to pop-up out of a page, or cause a valve or curtain to open and close.

The light emitting devices would flash and the audio device would emit a sound while the positions of the characters are changed. The devices could be positioned away from the moving disk or moving objects to illuminate through the apertures on a book page/cover. The devices could also be positioned behind the moving disk or objects. A processing device is connected to the light emitting device, the audio device and the electro-mechanical device to simultaneously activate and de-activate the electro-mechanical device, the plurality of lighting devices and the audio device.

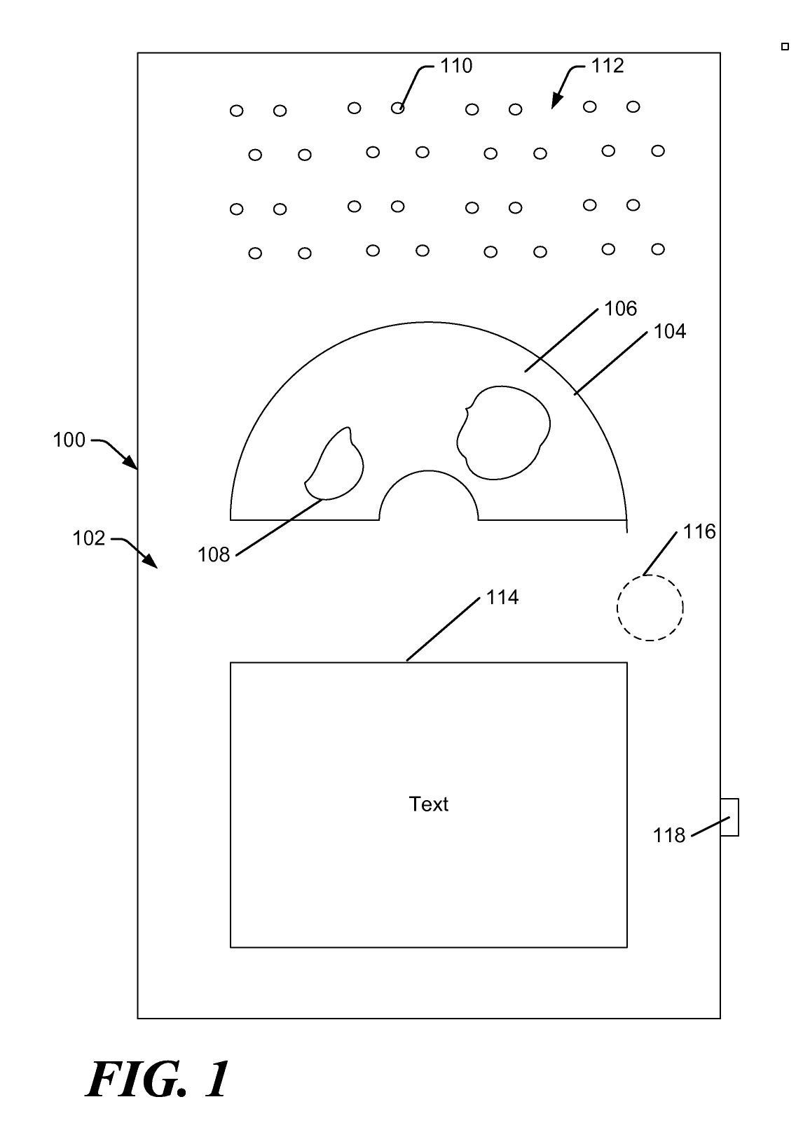

These techniques help provide an audio and visual experience for a book reader. Various examples of the construction of the device to provide the audio and visual experience are described below with reference to FIGS. 1-6.

### Example System Architecture

FIG. 1 illustrates an example an exemplary book cover 100 that incorporates sound, light, and mechanical movement. The book cover 100 includes a binding 102 having an opening 104 through which an object 106, such as a rotating or moving disk, is displayed. Object 106 is moved by an electrical mechanical device (not shown). Disposed on the surface of the object 106 are multiple characters 108. Located on book cover 100 are small openings 110 though which a light emitting device 112 flashes light. Light emitting device 112 may include fiber optic cables (not shown) connected to a light source. The cover (or page) of the book may also display text or other graphics images 114. An audio device 116 may be positioned behind binding 102 to play audio.

An input device, such as switch 118, may be integrally connected to the adjacent a side, front or any other the portion of book cover 100 and may be activated by the reader of the book depressing the input device. When switch 118 is activated (e.g. by being pressed or touched by a user), an event is activated. In one embodiment, this event may include an electromechanical device moving object 106 to display different characters. Alternately, this event may include a light source emitting light through the cover. The light source may include many light sources that may individually be turned off and on to simulate movement.

The switch 118, when pressed, may further result in the activation of the audio device 116 and activation of the light emitting device 112. Although the electromechanical device, audio and light emitting device is described as being activated in response to the switch 118 being pressed, such devices may also be activated by opening a cover of the book or a book reader changing a page in the book to trigger the sensor. In one implementation, when switch 118 is pressed a second time, the movement of electrical mechanical device, the sound emanating from audio device 116 and the light from light emitting device 112 are terminated.

Light emitting device 112 may be configured in the book cover as a series or combination of lights which are used to pinpoint positions on a map of the earth or sky. Such lights may be accompanied by a sound illustration and/or voice description activated by user operated switches (e.g. switch 118) incorporated into either book cover 100 or as additional foldout features.

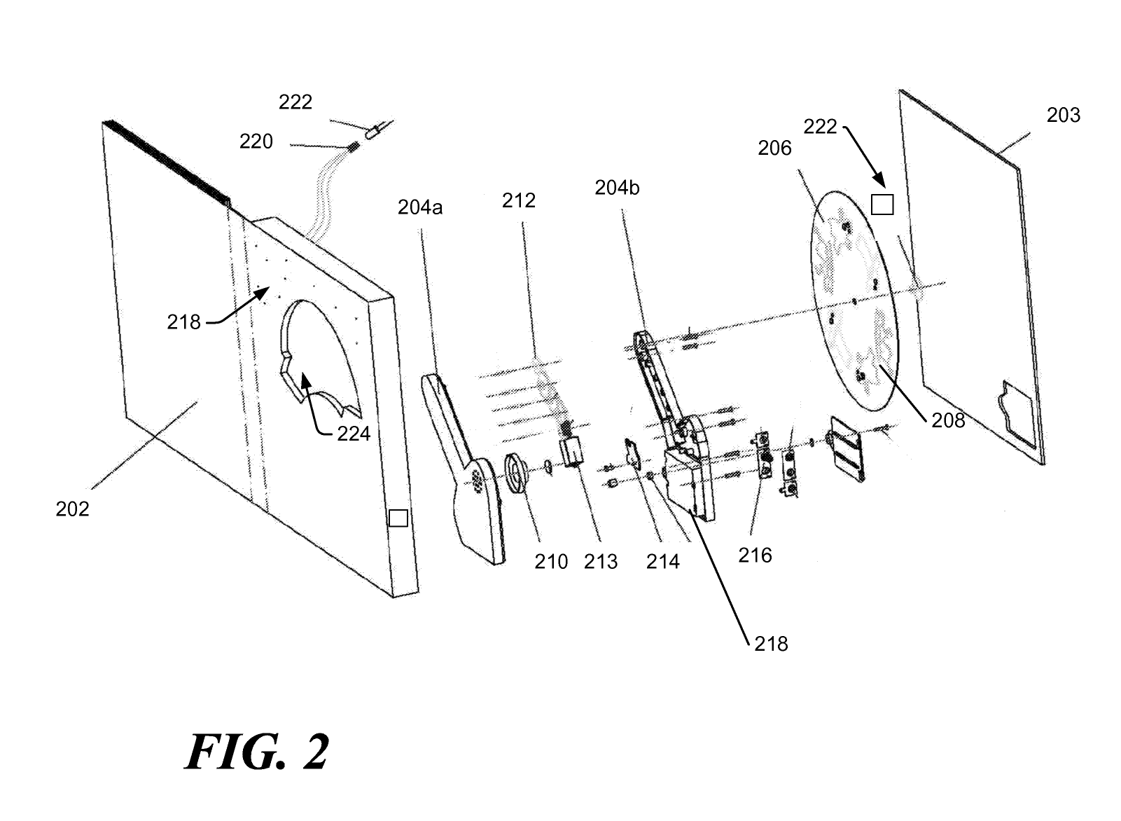

FIG. 2 illustrates an exploded view of the components that are used to construct the exemplary book 200 (referred to as 100 in FIG. 1). The exemplary book 200 includes a cover binding 202, a back binding 203 and an electrical mechanical device 204a and 204b (collectively referred to herein as electrical mechanical (or electro-mechanical) device 204). The electrical mechanical device 204 is sandwiched between the bindings 202 and 203 and holds a device, e.g. content disk 206. Content disk 206 has characters or other content 208 engraved on or attached to its surface.

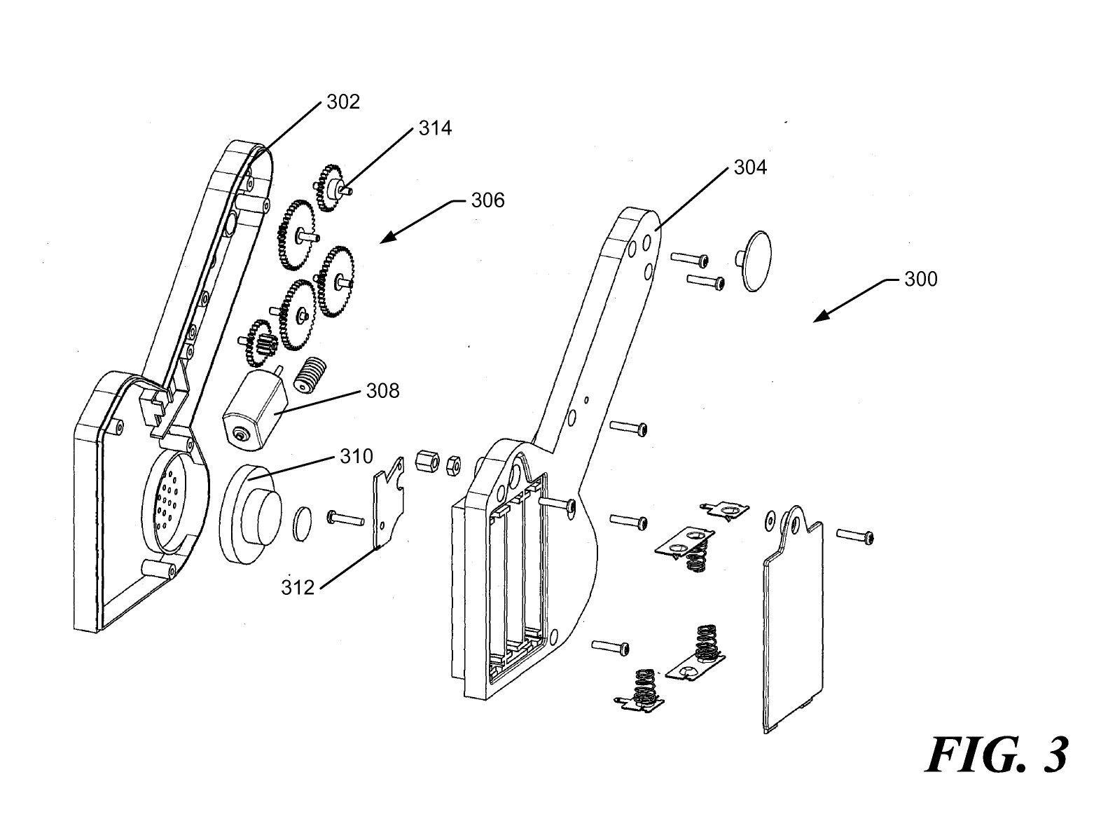

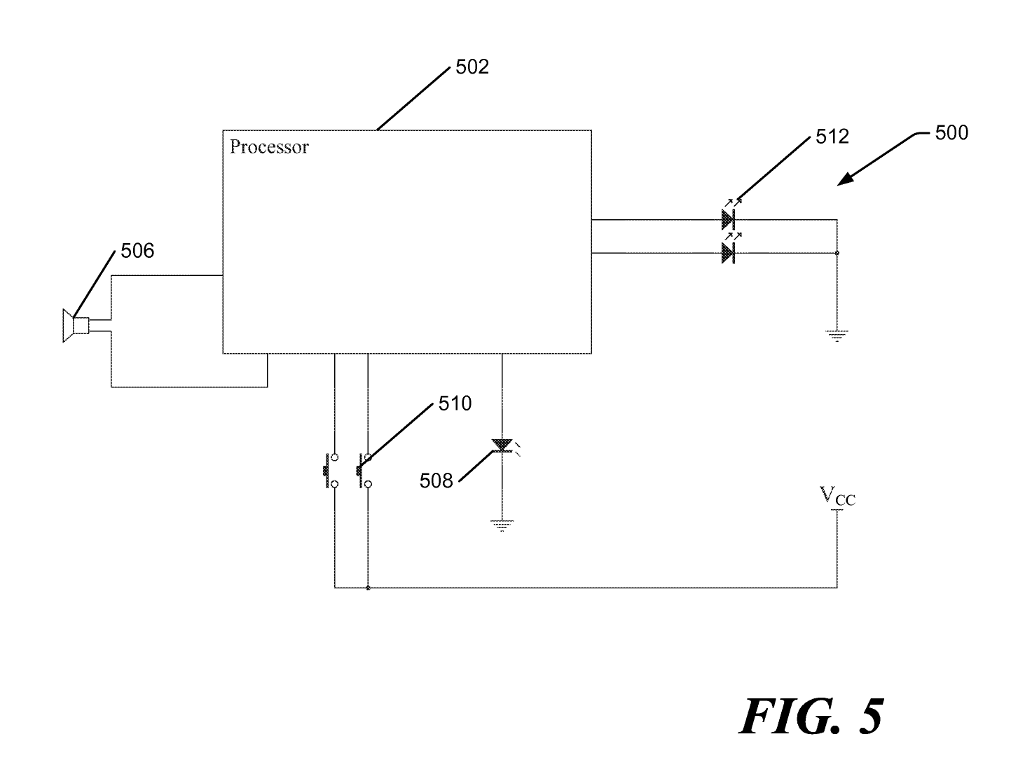

Electrical mechanical device 204 is connected to an audio device or speaker 210, contains a rotational assembly 212, a motor 213, a circuit 214, an input device, e.g. switch component 216, a light source 222, a battery compartment 218 for powering device 204, circuit 214, the light source 222 and the audio device 210. Further details of mechanical device 204 are described in FIG. 3. Further details of circuit 214 are described in FIG. 5.

Cover binding 202 has apertures 218 through which fiber optic cables 220 are connected. Cables 220 receive light from light source or emitter 222 and radiate the received light through apertures 218. Alternately emitter 222 may be positioned behind disk 206 to light individual characters embedded on disk 206. Light source 222 is activated by circuit 214. Cover binding 202 includes an opening 224 through which disk 206 and the content 208 on disk 206 appear.

During operation and in response to the input device 216 being pressed by the book reader (also referred to herein as “a user”), circuit 214 transmits a signal to electrical mechanical device 204 to indicate to mechanical device 204 to rotate and/or move disk 206. Simultaneously circuit 214 provides a signal to play a song or other sounds via audio speaker 210 and provides a signal to light emitter 222 to provide light via fiber optic cables 220 to apertures 218 on cover 202.

When disk 206 is moved, characters on the disk 206 appear through opening 224. In one implementation, the disk 206 rotates in a circle. In another implementation, disk 206 moves back and forth. Disk 206 continues to rotate for a predetermined period of time, e.g. the length of a song, or until the input device 216 is again activated. Although disk 206 is shown to rotate, other implementations may be envisioned that do not include a rotating disk but rather contain an object having multiple lights that flash to simulate rotation, a back and forth action or other movement. These lights could be synchronized with the audio to flash at specific times in the audio. It is also envisioned that other objects besides disk 206 could be moved by the electrical mechanical device, (e.g. a curtain, or a flap or any other object, such as the objects mentioned previously herein).

FIG. 3 illustrates an exploded view of the components that are used to construct the exemplary electrical mechanical device 300 (204 in FIG. 2). Device 300 includes a front portion 302 and a rear portion 304. Disposed in mechanical device are gears 306 and motor 308 to turn gears 306. Audio speaker 310 (speaker 210 in FIG. 2) is mounted in the front portion 302. Circuit 312 (circuit 214 in FIG. 2) is also mounted between front portion 302 and rear portion 304. An object, e.g. disk 206 (FIG. 2), is mounted to an axis of one of the gears 306, e.g. gear 314. Gears 306 rotate when motor 308 is activated to turn disk 206. Gears 306 may turn disk 206 so that disk rotates completely in a circle around a center point, or may be activated so that disk 206 rotates in a first direction and then reverses and rotates in the opposite direction.

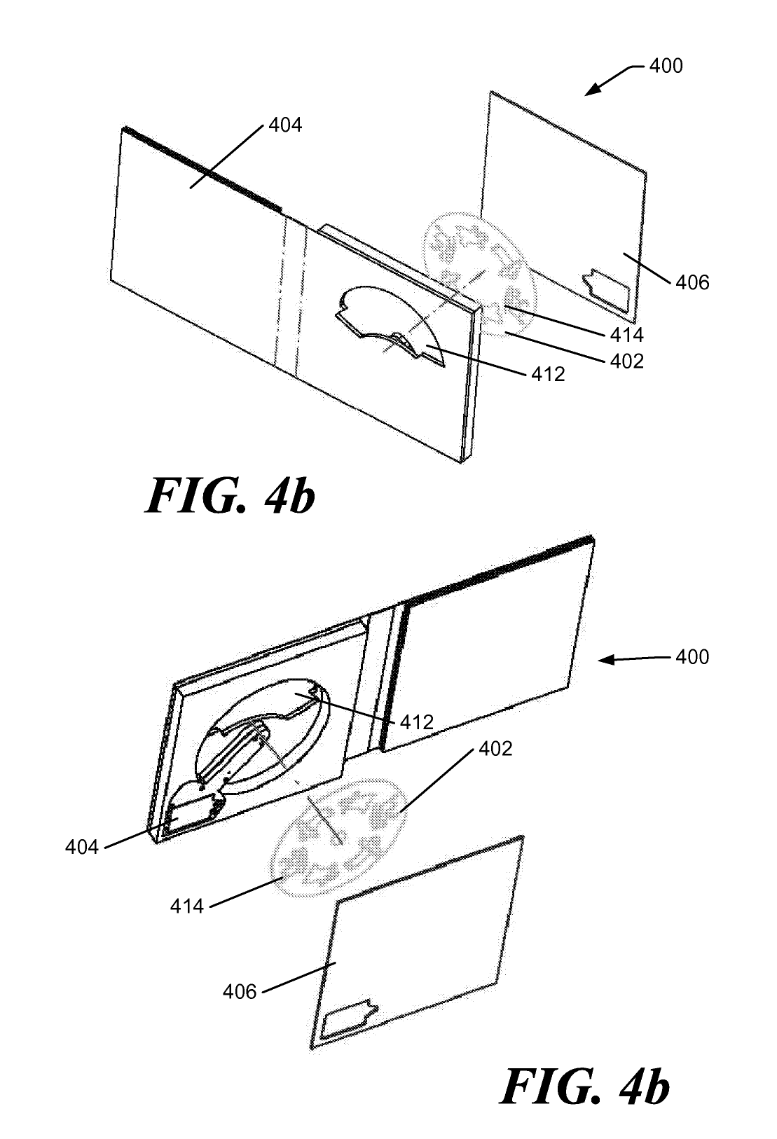

FIGS. 4a and 4b illustrates exploded views of a book cover 400 (100 in FIG. 1) incorporating an exemplary object or disk 402 (106 in FIGS. 1 and 206 in FIG. 2) containing content. The disk 402 is shown mounted to electromechanical device 404 between a front portion 406 of cover 400 and a back portion 406 of cover 400. Although disk 402 and electromechanical device 404 are shown mounted to the front portion 406 of book cover 400, they may be mounted to one or more pages of the book or the rear cover 410. Disk 402 may be mounted such that characters 414 are viewed through opening 412 in the cover. When disk 402 is rotated, new characters 414 on the disk 402 appear through the opening while other characters on disk 402 are rotated behind the cover so that they are no longer able to be viewed. Light emitting devices (not shown) may be positioned behind disk 402 to illuminate the characters on the disk. Such light emitting devices may be turned off and on at specific times in the audio to illuminate the characters. For example the light emitting devices may be turned on when a sound of thunder occurs in the audio to light up a jagged character line on the disk to simulate lightning.

FIG. 5 illustrates a schematic diagram of a circuit 500 that includes a processing device 502 for controlling the electrical mechanical device 504, audio device 506 (such as a speaker) and light emitting device 508 (such as a light emitting diode (LED). Processing device 502 is also connected to an input device, such as switch 510, which may be activated by the book reader. Processing device 502 may activate other light emitting devices, such as LEDs 512, to indicate that power is present or that circuit 500 is running.

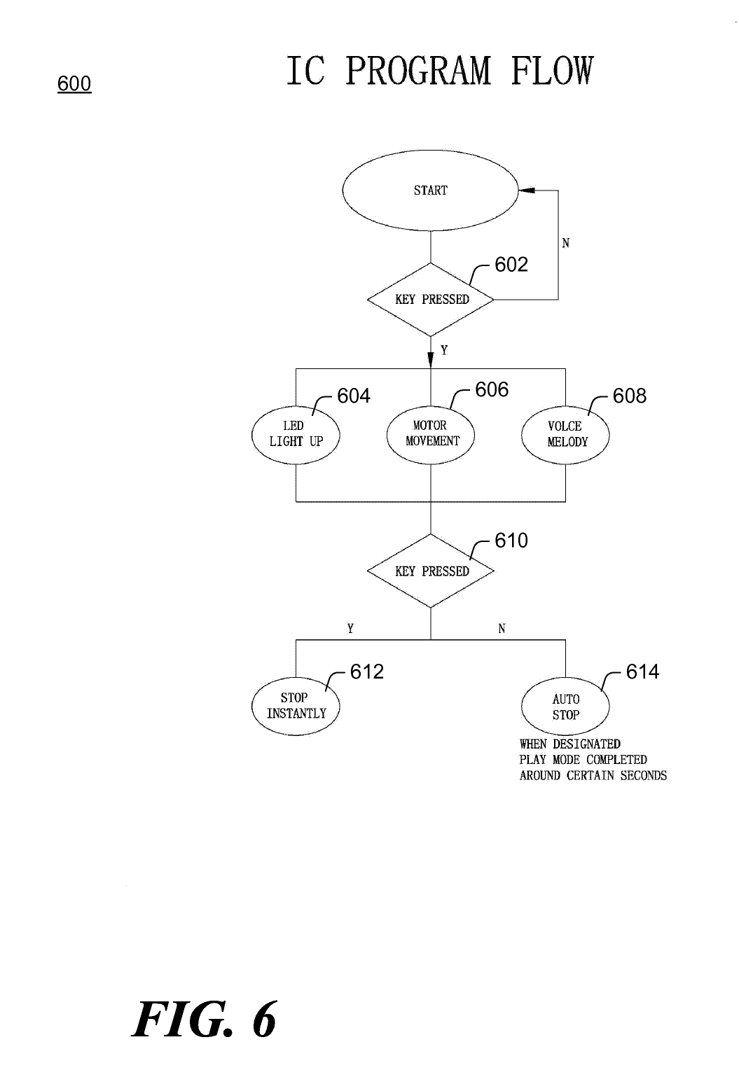

Processing device 502 includes a memory (not shown) for holding a program to simultaneously active the audio, light emitting device and activating the electrical mechanical device 504. Processing device 502 may internally store data such as an encoded audio signal. Thus when device 502 is activated, it may play a song, generate a particular sound or provide an audio voice. An exemplary program executed by processing device 502 is described in FIG. 6.

### Exemplary Process

Exemplary methods are described below that implement an adaptation algorithm to reduce collisions. However, it should be understood that certain acts need not be performed in the order described, and may be modified, and/or may be omitted entirely, depending on the circumstances. Moreover, the acts described may be implemented by a computer, processor or other computing device based on instructions stored on one or more computer-readable media. The computer-readable media can be any available media that can be accessed by a computing device to implement the instructions stored thereon.

FIG. 6 shows one example implementation of a process 600 implemented using the processing device 502 (FIG. 5) to produce synchronized sound, light, and mechanical movement on the book.

In block 602, the processing device 502 makes a determination whether the input device, e.g. switch 510, has been activated. The processing device 502 continues to repeat block 602 until the input device is activated. If the input device, e.g. switch 510, has been activated by the book reader, the processing device 502 indicates a first event has begun by providing a signal in block 604 to light up the light emitting devices 508, e.g. the LED. The processing device simultaneously provides a signal to electromechanical device 404 to begin to turn the disk in block 606 and provides a voice, audio sound or other melody in block 608 to the audio device 506. The disk may be rotated so that objects to appear on a page in the book related to words in song. For example if the word “cow” was announced in a song, a “cow” character may appear through the opening in the book. Alternately the specific characters on the disk may be specifically illuminated by the light emitting devices (positioned behind the disk). The characters may be illuminated at specific times in the audio. Further if subsequent characters were announced in a song, the disk may be rotated, moved and/or synchronized with the audio so that those characters would appear.

In block 610, a determination is made whether the input device, e.g. switch 510, has again been activated by the book reader. If the input device has been activated (“Yes” in block 610), then the light emitting device 508, the audio device 506 and the electromechanical device 404 are stopped in block 612. If the input switch has not been terminated (“No” in block 610), a determination is made, whether a second event has occurred. Examples of such a second event include a song has completed, or a certain amount of time has elapsed since the first event. If such second event has occurred, the light emitting device 508, the audio device 506 and the electromechanical device 404 are stopped in block 614. In one implementation, the object movements, the audio and the light flashing may be terminated in response to a closing of the cover of the book.

After block 612 or 614, the process 600 repeats in block 602 where a determination is made whether the input device has been selected.

### CONCLUSION

In closing, although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

1. A method for displaying content in a text book that includes an input device, an electromechanical device, a light emitting device and an audio device, the method comprising:
providing an electric signal to start an event using the input device coupled with the book; and
in response to the signal, physically moving an object within the book with the electromechanical device while simultaneously flashing light from the light emitting device and playing a sound with the audio device.

2. The method as recited in claim 1 wherein the input device is a button, a switch or a sensor connected to a cover or page of the book, and wherein the method further comprises providing an electric signal in response to depressing the button, opening a cover of the book or changing a page to trigger the sensor.

3. The method as recited in claim 1 wherein the input device is a button integrally connected to the book.

4. The method as recited in claim 1 wherein the electromechanical device includes a rotating a display wheel, a flap or curtain that continuously opens and closes, an object that continuously moves back and forth in two directions, an electrical mechanical pop-up object, or a valve that opens and closes.

5. The method as recited in claim 1 wherein the flashing light from the light emitting device includes an LED that is coupled adjacent a cover of the book.

6. The method as recited in claim 1 wherein the playing a sound with the audio device comprises playing a song.

7. The method as recited in claim 6, wherein the objects include characters embedded on a surface of the objects, and wherein the method further comprising moving characters to appear on a page in the book related to words in song; and illuminating those characters with the light emitting device at specific times in the sound.

8. The method as recited in claim 1 further comprising terminating movement, the audio and the light flashing after a predetermined period of time from when the electrical signal is provided to start the event.

9. The method as recited in claim 1 further comprising terminating object movement, terminating the audio and terminating the light flashing in response to a second activation of the input device.

10. The method as recited in claim 9 further comprising terminating object movement, terminating the audio and terminating the light flashing in response to a closing of the cover of the book.

11. The method as recited in claim 1 wherein the electromechanical device, the light emitting device and the audio device are coupled with the cover of the book.

12. The method as recited in claim 1 wherein the text book has multiple pages, and wherein the electromechanical device, the light emitting device and the audio device are connected to a page of the book, and wherein a character on the electromechanical device is visible to a book reader only when book is opened.

13. A book comprising:
a movable object having a surface in which characters within a book are attached;
an electro-mechanical device to move the object to change an orientation or position of the characters;
a plurality of light emitting devices;
an audio device; and
a processing device to simultaneously activate the electro-mechanical device the plurality of lighting devices and the audio device.

14. The book as recited in claim 13 wherein the plurality of light emitting devices are connected to cover or pages of the book to periodically flash when electro-mechanical device moves the object.

15. The book as recited in claim 13 wherein the audio device is operative to play a pre-recorded song or play a pre-recorded voice.

16. The book as recited in claim 13 wherein the processing device is activated by a user selecting an input device, opening a cover, or changing a page in the book.

17. The book as recited in claim 13 wherein the electromechanical device and processing device are operable to move characters such that the characters appear visible on a page to a book reader, and wherein the processing device is operable to move the characters in synchronization with words in song relating to the characters.

18. The book as recited in claim 13 wherein the processing device is operative to terminating movement, the audio and the light after a predetermined period of time from when the electrical signal is provided to start the event.

19. The book as recited in claim 14 wherein the processing device is operative to terminate movement, audio and light flashing after pressing the input device, closing a cover to the book, or changing a page in the book.

20. An apparatus comprising:
a movable object having a surface in which graphic images are attached;
an electro-mechanical device coupled with the apparatus to move the object to change an orientation or position of the graphic images;
a plurality of switchable electrically activated light emitting devices coupled with the apparatus;
an audio device coupled with the apparatus; and
a processing circuit to simultaneously activate the electro-mechanical device, the plurality of lighting devices and the audio device.

21. The apparatus as recited in claim 20, wherein the apparatus further comprises an input device, and wherein the processing device is operative to simultaneously activate the electro-mechanical device in response to selection with the input device.

22. The apparatus as recited in claim 21 wherein the input device comprises a sensor disposed in of a book, and wherein the input device is operative to be selected when a book cover is opened or a page is changed in the book.

23. The apparatus as recited in claim 21 wherein the audio device is operative to play a song with graphic images that appear in synchronization with corresponding words in the song relating to the graphic images.

24. The apparatus as recited in claim 20 wherein the electromechanical device, the light emitting devices and the audio device are mounted to the cover of the book.
